(19) United States
(12) Patent Application Publication
(10) Pub. No.: US 2005/0102515 A1
(43) Pub. Date: May 12, 2005

(54) Controlling read and write operations for digital media

(76) Inventors: Dave Jaworski, Franklin, TN (US); Brad Edmonson, Franklin, TN (US); Robin Pou, Dallas, TX (US)

Correspondence Address: FISH & RICHARDSON P.C., 5000 BANK ONE CENTER, 1717 MAIN STREET, DALLAS, TX, 75201, US

(21) Appl. No.: 10/870,708

(22) Filed: Jun. 17, 2004

Related U.S. Application Data
(63) Continuation-in-part of application No. 10/726,284, filed on Dec. 2, 2003.
(60) Provisional application No. 60/444,581, filed on Feb. 3, 2003.

(51) Int. Cl. H04L 9/00

(52) U.S. Cl. 713/168

(57) ABSTRACT

Techniques and systems for managing digital rights involve monitoring an interface of a user device for attempts to transfer files and detecting an attempt to transfer a file through the interface. When a file is identified as a copy of a protected file, a determination is made as to whether a license for the file exists. The attempted transfer of the file through the interface is selectivity allowed based on a result of the determination.

### CROSS-REFERENCE TO RELATED APPLICATIONS

This application is a continuation-in-part of, and therefore claims priority from, U.S. patent application Ser. No. 10/726,284, filed on Dec. 2, 2003, which claims priority from U.S. Provisional Application No. 60/444,581, filed on Feb. 3, 2003, both of which are incorporated herein by reference.

### TECHNICAL FIELD

This description relates to digital rights management, and more particularly to controlling copying of protected files through a device interface.

### BACKGROUND

Over the past few years, digital distribution of media has grown at a rapid rate and continues to expand. In the music industry, for example, digital distribution of song files was made popular and convenient by peer-to-peer online file sharing supported by such companies as Napster, KaZaA, Grokster, and Morpheus. The use of such services for piracy of digital media has cost music companies and content owners amounts that are estimated in the billions of dollars. Concerns about piracy and the lack of effective solutions for preventing illegal file sharing initially led the music industry and other content owners to resist fully embracing the potential of digital distribution of media. Content owners have now at least implicitly acknowledged that digital distribution is the future of distribution through their endorsement of digital subscription services and the growing availability of online digital music stores.

Even as digital distribution is becoming more prevalent, physical piracy of media continues to damage content owners by reducing sales. CD-R (CD-Recordable), CD-RW (CD-Rewritable), DVD-R (DVD-Recordable), and DVD-RW (DVD-Rewritable) drives have decreased in cost, making them more accessible to larger numbers of consumers, and have made it possible to create high quality copies of media. Left unchecked, physical piracy (i.e., illegal copying of files to and from CDs and DVDs) is likely to continue to be a problem for content owners as the transition from physical to digital distribution channels continues. Moreover, even if content owners' efforts to curb piracy through civil and criminal penalties and/or if technologies are implemented that help prevent piracy through digital distribution, physical piracy could continue to be a problem. Thus, media that is legally obtained through the purchase of the media through physical or digital distribution channels might be “burned” (i.e., written) to a CD or DVD and/or “ripped” (i.e., copying music tracks or other media off of a CD or DVD and typically converting them to some form of compressed file, such as an MP3 file) to a computer in a manner that constitutes illegal piracy.

### SUMMARY

Techniques can be implemented for preventing users from transferring unlicensed media files between a computer or other device and a storage medium. Commonly used software for copying files from a CD to a computer use some form of compression to reduce the size of the file and to convert the file into a format that can be read by media players. Such compression generally preserves the original level of sound quality but results in an irrecoverable loss of data. If the compressed file is subsequently transferred to a CD-R or other writable storage media, the file is typically converted to an uncompressed form so that the file (e.g., in the form of a music track on a CD) can be played on a conventional CD player. As a result of the prior compression, the digital bits of the uncompressed file differ from those of the original file, although the change in sound quality may be imperceptible. Changes in digital bits can be used, in conjunction with file recognition algorithms, to identify copies of protected (e.g., copyrighted) media and to prevent transfers of such media unless the user possesses a valid license to the media.

In one general aspect, digital rights are managed by monitoring an interface of a user device for attempts to transfer files and detecting an attempt to transfer a file through the interface. The file is identified as a copy of a protected file, and a determination of whether a license for the file exists is made. The attempted transfer of the file through the interface is selectively allowed based on a result of the determination.

Implementations may include one or more of the following features. Identifying the file as a copy of a protected file involves using a file recognition algorithm, which can further involve calculating a hash for the file and comparing the calculated hash for the file with a predetermined hash for one or more of the protected files. The attempted transfer is prevented if the calculated hash does not match the predetermined hash, and a license for the file is offered for purchase. A transfer of the file is allowed only after receiving an acceptance of the offered license.

The protected files can be song or other media files, and the file can be identified as a copy based on an order of the song or media files on a storage medium. The determination of whether a license for the file exists involves searching for the file in a license database. The license database is associated with a user or the user device. Monitoring an interface of a user device can include monitoring a driver of the interface.

A determination that a file is a copy of a protected file can include determining that the attempt to transfer the file through a user interface includes converting the file from a compressed format and writing the converted file to a removable storage medium.

One or more databases store data identifying licenses for protected files and store data relating to protected files. The interface can be a compact disc reader, a compact disc writer, a DVD reader, and/or a DVD writer.

The details of one or more implementations are set forth in the accompanying drawings and the description below. Other features will be apparent from the description and drawings, and from the claims.

### DESCRIPTION OF DRAWINGS

FIG. 1 is a block diagram of a representative digital rights management system for controlling transfers of protected media.

FIG. 2 is a flow diagram of a process for identifying copies of protected files.

FIG. 3 is a flow diagram of one implementation of the process described in FIG. 2.

FIG. 4 is a flow diagram of another implementation of the process described in FIG. 2.

Like reference symbols in the various drawings indicate like elements.

### DETAILED DESCRIPTION

When a CD is copied or ripped into a computer, the files (e.g., the song tracks) are typically compressed by a codec into a format such as MP3, AAC, WMA, or the like for use on the computer and/or on other devices (e.g., an MP3 player). Compressing a file, by its nature, results in a loss of some data bits. Codecs are generally designed to remove some data bits from a file in a manner that causes little or no deterioration in sound quality. The compressed file can also be decompressed and burned to a CD-R, for instance, without any perceptible deterioration in sound quality from the original. If an attempt is made to re-rip the file from the CD-R, however, an analysis of data bits in the file can reveal distinctions between the re-ripped file and the data bits of the original file. These distinctions can be used to determine that the file is a copy. In general, a hash or checksum of a particular file to be analyzed can be compared with a hash or checksum of an original version of the particular file to determine whether the particular file is a copy. Alternatively, in some implementations, a digital “signature” or “fingerprint” (e.g., representing other characteristics of the file) for the particular file and the original version can be compared to determine whether the particular file is a copy.

Although the techniques are described in the context of music files that are transferred to and from various types of CDs, the techniques can also be used in connection with other types of proprietary digital files, including music and other recordings, movies and other video, books and other written works, multimedia files, and other files, such as those that pertain to the financial, legal, medical, gaming, and software industries. In addition, the described techniques can be used to detect copies of files that are transferred to or from other storage media, such as a DVD.

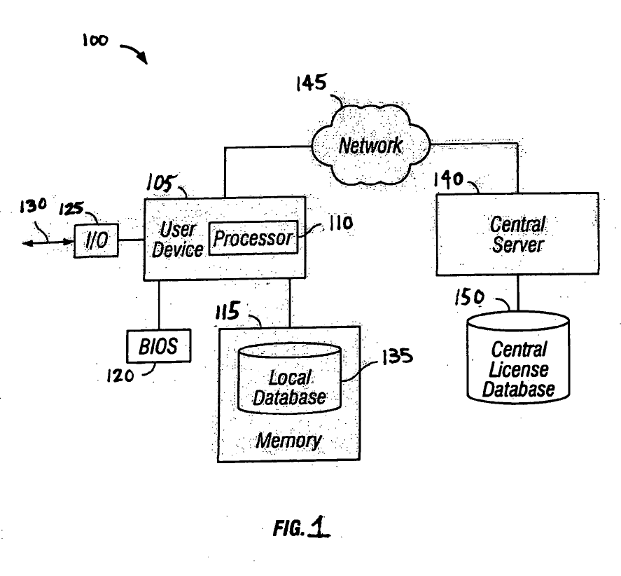

FIG. 1 is a block diagram of a representative digital rights management system 100 for controlling transfers of protected media. A user device 105 includes a processor 110, which executes instructions stored in a memory 115 and/or other storage mediums (not shown) that are connected to the user device 105. The user device may include a BIOS (basic input/output system) 120 or some other non-volatile memory that stores basic information about the user device 105. The user device 105 includes one or more I/O ports 125 that permit files and other data to be moved and/or copied onto and off of the user device 105 (as indicated at 130). The I/O ports 125 can include, for example, CD, CD-R, or CD-RW drives and/or DVD, DVD-R, or DVD-RW drives for writing to and reading from CD and/or DVD storage media. Each drive may be controlled by a device driver, which is a set of software instructions stored in the memory 115 and executed by the processor 110 to direct operations of the drive.

The processor 110, in accordance with instructions stored in the memory 115, monitors files and other data that pass through the I/O port 125 (e.g., by monitoring calls to the device driver and/or between the device driver and the corresponding CD or DVD drive) for purposes of identifying protected (e.g., copyrighted) music, video, software, or other files, determining whether such files are copies of protected media, and selectively allowing or disabling transfers of the files through the I/O ports 125 (e.g., by controlling the device driver for a CD or DVD drive). For example, if a particular file is identified as a protected file and is determined to be a copy, the processor 110 may determine whether the user device 105 or a user thereof has a license to the protected file. If so, one or more transfers of the particular file may be allowed. If no license is found, a user of the device 105 may be required to accept and/or purchase a license to the protected file before any transfer of the particular file is allowed.

The memory 115 may include a local database 135 that stores license information for files that are licensed to be used on the user device 105 and/or by one or more users. Access to the local database 135, or to the information contained in the local database 135, may require one or more keys stored in the BIOS 120 or other non-volatile storage area. Such keys may be unique to the user and/or the user device 105, and the process for accessing the local database 135 may be such that the keys and/or the license information stored in the local database 135 are only valid for the particular user device 105. For example, if a user attempts to make an unauthorized copy of the key(s) and/or the license information on an alternative device, access to the files that are licensed on the user device may be denied on the alternative device unless a new unique key is generated for, and license information is stored on, the alternative device. License information on a particular device may be updated at a future date, updating usage rights or removing access to a file or files. One example where the capability to perform such an update is desired is de-licensing an old computer.

The user device 105 may communicate with a central server 140 through a network 145, which may include one or more of a wireless network, a LAN, a WAN, the Internet, a telephone network, and any other network for transferring data. Communications between the user device 105 and the central server 140 may be performed using a secure channel, such as the Secure Sockets Layer (SSL), and/or may use encryption, such as PGP. The central server 140 may provide services that support the digital rights management system 100, such as generating keys using, at least in part, information communicated from the user device 105 over the secure connection and validating keys and license information periodically or when attempting to license new media. In addition, the central server 140 may provide access to a central license database 150 that stores and identifies licenses held by individual users and that stores key validation information. Storage of license information in the central license database 150 provides redundancy (e.g., in case there is a corruption of a volatile or non-volatile memory area of a user's device), allows a re-creation of a licensed data environment on another device, allows for transfers of licenses between a user's devices, and allows for remote access of license information by the user using a device without a volatile or non-volatile memory area (e.g., some types of cell phones).

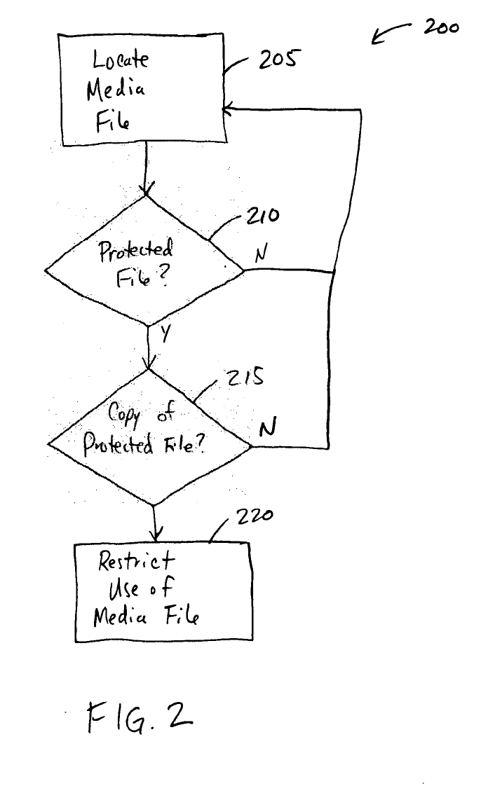

FIG. 2 is a flow diagram of a process 200 for identifying copies of protected files. A potentially protected media file is located (step 205) by, for example, monitoring files that pass through an I/O port or searching for files on a hard drive. Files that meet certain criteria, such as being in a particular format and/or having particular file name extensions, can be identified as potentially protected media files. For example, algorithms can be used to detect a media file type and a likelihood that the media file is of interest (e.g., represents a potentially protected work). Generally, these algorithms examine internal attributes of the file, instead of simply identifying the file type based on the file extension. Media files that are determined not to be of interest, because they do meet the criteria, may be allowed to pass or otherwise ignored without further analyzing the media file.

The potentially protected media file is further analyzed to determine whether the media file is actually a protected file (step 210). A protected file can be a file that includes protectable subject matter (e.g., a copyrighted work) and/or proprietary data (e.g., a trade secret). This determination can be made by using file identification software in an attempt to identify the media file. For example, the file identification software may determine if the media file represents a known song or movie (e.g., in MP3, Windows media, or some other format). This file identification may be performed by software implementing, for example, Gracenote, Inc.'s CDDB technology and/or the techniques described in Roberts, et al., U.S. Patent Application Publication No. 20030028796, filed Jul. 31, 2002, Roberts, U.S. Patent Application Publication No. 20030046283, filed Oct. 29, 2002, and/or Wells, et al., U.S. Patent Application Publication No. 20030086341, filed Jul. 22, 2002, all of which are assigned to Gracenote, Inc. and all of which are incorporated herein by reference. This technology extracts a digital fingerprint from a digital file and compares the extracted fingerprint to a database of known works. Algorithms are used to identify the specific media file (e.g., the specific song, movie, photo, written work, etc.). Fingerprinting data that allows the specific media file to be identified may be stored at a central server (e.g., central server 140 in FIG. 1) and accessed using an Internet connection. Some files may be of a relevant file type but may not be recognized (e.g., if the media file represents a recording generated by the user or if access to a central database of digital fingerprints is not available). In some implementations, data for a limited number of media files (e.g., the two thousand most popular song files) may be stored locally on the computer (e.g., in memory 115 of FIG. 1) for quick access. The locally stored fingerprinting data may be periodically updated from the central server (e.g., as the popularity of song files changes).

The file identification techniques described above allow for accurate identification of the media file even if someone has attempted to disguise the media file (e.g., by changing the file name, extensions, or other attributes) and regardless of whether the media file is received in compressed or uncompressed form (e.g., using standard practices for reading compressed information). Such techniques offer a very low error rate of less than 2% (less than 1% false negatives and less than 1% false positives).

Other file identification techniques may also be used, such as watermarking and fingerprinting techniques, as are known in the field of digital rights management. In some cases, it may not be necessary to identify the media file using complex file identification techniques. Instead, the media file may be identified based on a file name or using file ID attributes, which may be contained in or with the media file and may be designed to be tamper-resistant. Thus, media files can be identified using implicit characteristics of the file (e.g., a fingerprint or watermark) or using explicit file characteristics (e.g., a file identifier stored in a file header). If the media file is not a protected file, the process 200 can return to step 205 to locate another potentially protected file.

If the media file is determined to be a protected file, the media file can be further analyzed to determine whether it is a copy of the protected file (e.g., as opposed to an original, commercially purchased CD that contains the media file) (step 215). In particular, a hash or checksum for the media file is calculated and compared with a previously calculated hash or checksum for the protected file. The previously calculated hash or checksum may be a part of, or stored along with, the fingerprinting data that is used to identify the file. Differences between the calculated hash for the media file and the previously calculated hash are indicative of prior compression or imperfect ripping of an original CD, CD track, or other protected file. In some implementations, the hash for the protected file can be calculated in parallel with the hash of the media file of interest, rather than using a previously calculated hash for the protected file. If the media file is determined to be a copy, this determination can be used to restrict use of the media file (step 220) by preventing further copies or other transfers of the media file or for other purposes, such as requesting that a user of a device purchase a license to continue using the media file. Otherwise, if the media file is not a copy, the process 200 can return to step 205 to locate another potentially protected file.

Typically, the techniques used to identify the media file and to determine that the media file is a protected file are sufficiently robust to identify the media file even if it is a copy. A hash of the protected file may be one of many factors used in the file recognition techniques. The robustness of the file recognition techniques may involve using the hash to look for similarities or other characteristics that, when combined with other features of the digital fingerprint, tend to indicate that the media file is a particular protected file. By analyzing the hash for the media file to determine whether it is identical (or possibly only substantially identical) to the hash for the original protected file, however, it is possible to determine that the media file is a copy.

Other techniques for determining that the media file is a copy of a protected file can also be used. For example, if the media file of interest is located on a CD, an order of tracks on the CD can be examined to determine if they differ from one or more original CDs (i.e., the track may be included on multiple different original CDs, each of which can be compared to the CD containing the media file of interest). Other characteristics of the media file, such as a subset of the fingerprinting data used to identify the file as a protected file, can be used to determine whether the media file is a copy. In some implementations, the media file can be determined to be a copy if the media file is located on a computer hard drive, a CD-R, or some other writable storage medium. In particular, if the media file is an MP3 file or a song track on a CD-R corresponding to a song that is available for purchase only on a factory-produced CD and/or in a different file format, it may be possible to determine that the media file is a copy of the protected file. Even if a media file on a CD-R is an exact copy of the original protected file (and thus has an identical hash), a CD drive that reads the CD-R and/or the device driver that controls the CD drive may be able to distinguish between factory CDs and CD-Rs and thereby determine that the media file is a copy. Similarly, if a media file is being written from a hard drive to a CD-R (e.g., by converting the file from a compressed format and writing the converted file to the CD-R), it may be determined that the media file is a copy based on the fact that the media file is stored on a hard drive rather than a factory CD.

In some situations, the fact that the media file is stored on a hard drive or other writable storage medium does not necessarily indicate that the media file is an unauthorized copy of a protected file. For example, a digital media file might be purchased and delivered to a user's device over the Internet. Thus, the digital media file that is stored on the user's hard drive represents a quasi-original version of the media file because it is delivered as a result of an authorized purchase of the media file, even if it is delivered in a compressed form. Upon purchasing such a media file, a license database associated with the device and/or the user may be updated to indicate that the media file is licensed to the user. Subsequently, the user may be allowed to make copies of the digital media file based on data stored in the license database. In other words, even though the media file might normally be identified as a copy, the data in the license database may enable transfers of the media file, for example, to a CD-R, to another device, or to some other storage medium.

The number of transfers permitted may be limited in accordance with license data stored in the license database or with rules associated with the digital rights management software. For example, a counter in the license database may be decremented each time a copy or other transfer is made. If the media file is transferred to another device, however, the other device may not include a license database that enables additional copies or other transfers to be made. Accordingly, software on the other device may prevent further transfers of the media file even though additional transfers may be made from a device that includes or otherwise has access to the license database.

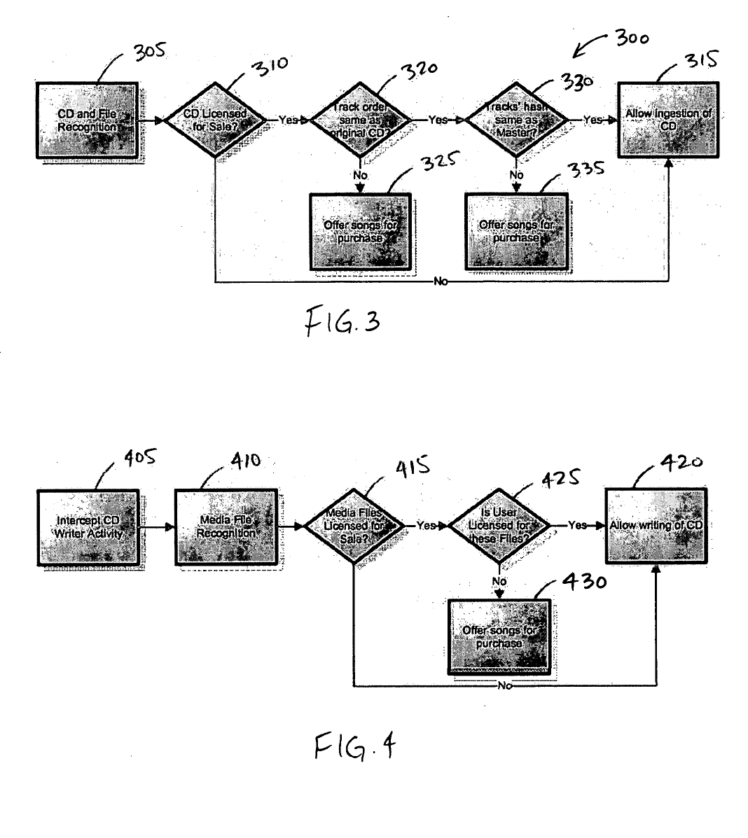

FIG. 3 is a flow diagram of one implementation of the process 200 described in FIG. 2. The illustrated implementation is a specific process 300 for controlling transfers of media files on a CD. CD and/or media file recognition is performed (step 305). For example, when a CD is inserted into a CD reader drive on a device, a file recognition algorithm is used to identify the CD and/or one or more media files on the CD. The file recognition algorithm can be implemented as software on the device. Alternatively, in some implementations, at least some functions of the file recognition algorithm may be performed on a remote server. Typically, recognition of a CD that includes multiple tracks is performed by analyzing the digital fingerprint of each track individually. In some implementations, however, a digital fingerprint for the entire CD can be used. Although not illustrated, if the CD and/or the files on the CD are recognized and a license to use the CD and/or the files is located, the CD may generally be accessed without having to complete the process 300.

After analyzing the CD with a file recognition algorithm, a determination is made as to whether the CD is licensed for sale (step 310). The general purpose of this determination is to identify CDs that, if they are not originals (e.g., factory-produced CDs), can be offered for purchase. If the CD is not recognized, it may generally be assumed that the CD is not licensed for sale. In some instances, the CD may be recognized even though it is not licensed for sale (e.g., where fingerprint data for the CD is stored in a recognition database, but the CD does not include copyrighted or otherwise protected content). If the CD is not licensed for sale, the CD can be accepted by the device, and files on the CD can be read or otherwise transferred to the device (step 315). If the CD is licensed for sale, then it is necessary to determine whether the CD is an original or a copy.

It is determined whether the track order of the CD is the same as that of the original CD (step 320). If not, the CD is a copy, and the tracks on the CD can be offered for purchase (step 325). The determination that is made at step 320 can also include determining whether the CD contains song files that, collectively, are not included on any commercially available CD, which also indicates that the CD is a copy. If the track order of the CD is the same as that of the original CD, it is determined whether the hash of one or more tracks on the CD is the same as the hash of the original, protected file (step 330). If not, the CD is a copy, and the tracks on the CD can be offered for purchase (step 335). Procedures for offering media files for purchase and obtaining a license to use the media files (as well as performing other digital rights management functions that can be used in connection with the techniques described here) is described in U.S. patent application Ser. No. 10/726,284, filed Dec. 2, 2003, which is incorporated herein by reference. If the user accepts the offer to purchase or otherwise license the tracks at either of steps 325 or 335, access to the CD can be permitted. In addition, if the hash of each track on the CD is the same as the corresponding hash of the original track, it can be assumed that the CD is an original, and access to the CD can be permitted (step 315).

FIG. 4 is a flow diagram of another implementation of the process 200 described in FIG. 2. The illustrated implementation is a specific process 400 for controlling transfers of media files to a CD, such as a CD-R. When instructions to write data are sent to a CD writer drive by a device driver on a user device, the instructions can be intercepted (step 405) and used to perform media file recognition (step 410). In some implementations, media file recognition is performed using the actual media file data that is transferred from the device driver to the CD writer. In other implementations, instructions to write data that identify where a media file is stored on the user device can be intercepted. Media file recognition may have been previously performed on the file at the identified storage location and, based on the location data contained in the instructions, the identity of the media file can be determined. If media file recognition has not previously been performed, then a file recognition algorithm may be used to identify the file at the identified location when the instructions are intercepted.

After identifying the media file, a determination is made as to whether the media file is licensed for sale (step 415). If not, writing of the file to a CD can be allowed to continue (step 420). If the media file is licensed for sale, however, it is determined whether the user and/or the user device are licensed to use the media file (step 425). This determination can be made, for example, by retrieving data from a local or remote license database. If no license is located, the media file can be offered for purchase (step 430). Unless a license is obtained, writing of the media file to a CD is prevented by, for example, disabling the device driver and/or the CD writer drive itself. If the media file is purchased or otherwise licensed and the license allows writing of the media file to a CD, writing of the media file to a CD is permitted. In addition, if the user and/or the user device already have a license to the media file, writing of the media file to a CD can be allowed (step 420).

The described techniques can be implemented in digital electronic circuitry, integrated circuitry, or in computer hardware, firmware, software, or in combinations thereof. Apparatus for carrying out the techniques can be implemented in a software product (e.g., a computer program product) tangibly embodied in a machine-readable storage device for execution by a programmable processor; and processing operations can be performed by a programmable processor executing a program of instructions to perform the described functions by operating on input data and generating output. The techniques can be implemented advantageously in one or more software programs that are executable on a programmable system including at least one programmable processor coupled to receive data and instructions from, and to transmit data and instructions to, a data storage system, at least one input device, and at least one output device. Each software program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory, a random access memory and/or a machine-readable signal (e.g., a digital signal received through a network connection). Generally, a computer will include one or more mass storage devices for storing data files; such devices include magnetic disks, such as internal hard disks and removable disks, magneto-optical disks, and optical disks. Storage devices suitable for tangibly embodying software program instructions and data include all forms of non-volatile memory, including by way of example semiconductor memory devices, such as EPROM (electrically programmable read-only memory), EEPROM (electrically erasable programmable read-only memory), and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the techniques can be implemented on a computer system having a display device such as a monitor or LCD (liquid crystal display) screen for displaying information to the user and a keyboard and a pointing device such as a mouse or a trackball by which the user can provide input to the computer system or a system which enables input and presents information via voice, symbols, or other means such as a Braille input and output system. The computer system can be programmed to provide a graphical user interface through which computer programs interact with users. With new technologies such as voice input and output, it is not a requirement to have a visual display to implement the described techniques.

The invention can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the invention (e.g., to accept and pay for digital media licenses), or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made. For example, the techniques can also be used to detect copies of protected files apart from attempts to transfer the files between a device and a storage medium. In addition, the process steps of FIGS. 2-4 do not necessarily require a particular sequence but can be performed in a different order and/or in parallel. Accordingly, other implementations are within the scope of the following claims.

1. A method for managing digital rights, the method comprising:
monitoring an interface of a user device for attempts to transfer files;
detecting an attempt to transfer a file through the interface;
identifying the file as a copy of one of a plurality of protected files;
determining whether a license for the file exists; and
selectivity allowing the attempted transfer of the file through the interface based on a result of determining whether a license exists.

2. The method of claim 1 wherein identifying the file as a copy of one of a plurality of protected files comprises using a file recognition algorithm.

3. The method of claim 1 wherein identifying the file as a copy of one of a plurality of protected files comprises:
calculating a hash for the file; and
comparing the calculated hash for the file with a predetermined hash for at least one of the plurality of protected files.

4. The method of claim 3 further comprising preventing the attempted transfer if the calculated hash does not match the predetermined hash.

5. The method of claim 4 further comprising offering a license for the file for purchase.

6. The method of claim 5 further comprising allowing a transfer of the file only after receiving an acceptance of the offered license.

7. The method of claim 1 wherein the plurality of protected files comprise media files.

8. The method of claim 7 wherein identifying the file as a copy is based on an order of the media files on a storage medium.

9. The method of claim 1 wherein determining whether a license for the file exists comprises searching for the file in a license database.

10. The method of claim 9 wherein the license database is associated with at least one of a user or the user device.

11. The method of claim 1 wherein monitoring an interface of a user device comprises monitoring a driver of the interface.

12. A method for managing digital rights, the method comprising:
detecting an attempt to transfer a file through a user interface;
determining that the file comprises a particular one of a plurality of protected files;
determining that the file comprises a copy of the particular one of the plurality of protected files; and
preventing a transfer of the file without a license for the file.

13. The method of claim 12 wherein determining that the file comprises a copy of the particular one of the plurality of protected files is based on an order of files on a storage medium.

14. The method of claim 12 wherein determining that the file comprises a copy of the particular one of the plurality of protected files is based on a comparison of a hash for the file and a hash for the particular one of the plurality of protected files.

15. The method of claim 12 further comprising:
offering a license to the file; and
permitting transfer upon acceptance of a license to the file.

16. The method of claim 12 wherein determining that the file comprises a particular one of a plurality of protected files comprises identifying the file using a file recognition algorithm.

17. The method of claim 12 wherein determining that the file comprises a copy of the particular one of the plurality of protected files comprises determining that the attempt to transfer the file through a user interface includes converting the file from a compressed format and writing the converted file to a removable storage medium.

18. A system for managing digital rights, the system comprising:
a user device including an interface for transferring data;
one or more databases storing data identifying licenses for protected files and storing data relating to protected files; and
one or more machine-readable media storing instructions for causing at least one processor to perform operations comprising:
identifying a file to be transferred through the interface using the data using a file recognition algorithm;
determining that the file is a copy of a protected file using the data relating to protected files;
determining that a license for the file is not stored in the one or more databases; and
disabling a transfer of the file based on the determination that a license for the file is not stored in the one or more databases.

19. The system of claim 18 wherein the interface comprises at least one of a compact disc reader, a compact disc writer, a DVD reader, or a DVD writer.

20. The system of claim 18 wherein determining that the file is a copy of a protected file comprises determining that a hash of the copied file differs from a hash of the protected file.

21. The system of claim 18 wherein the one or more machine-readable media store instructions for causing at least one processor to perform further operations comprising:
offering a license to the file; and
allowing the transfer of the file after receiving an acceptance of the offered license.

22. An article comprising a machine-readable medium storing instructions for causing one or more processors to perform operations comprising:
detecting a media file;
determining that the media file corresponds to a protected file; and
determining that the media file comprises a copy of the protected file by comparing a hash of the media file to a hash of the protected file.

23. The article of claim 22 wherein the machine-readable medium stores instructions for causing one or more processors to perform further operations comprising preventing access to the media file absent a license to the media file.

24. The article of claim 23 wherein the media file comprises a media track and preventing access to the media file comprises preventing at least one of reading the media track from a storage medium, copying the media track from a storage medium, or writing the media track to a storage medium.

25. The article of claim 23 wherein the machine-readable medium stores instructions for causing one or more processors to perform further operations comprising offering a license to the media file.

26. The article of claim 23 wherein determining that the media file corresponds to a protected file comprises using a file recognition algorithm to identify the media file.
